(19) United States
(12) Patent Application Publication
(10) Pub. No.: US 2005/0055561 A1
(43) Pub. Date: Mar. 10, 2005

(54) Data carrier

(76) Inventors: Thorsten Boker, Beijing (CN); Holger Sedlak, Egmating (DE); Jurgen Hammerschmitt, Ottobrunn (DE); Otto Winkler, Hebertsfelden (DE)

Correspondence Address: LERNER AND GREENBERG, PA, P O BOX 2480, HOLLYWOOD, FL, 33022-2480, US

(21) Appl. No.: 10/667,567

(22) Filed: Sep. 22, 2003

Related U.S. Application Data
(63) Continuation of application No. PCT/DE02/00540, filed on Feb. 14, 2002.

(30) Foreign Application Priority Data
Mar. 20, 2001 (DE) 101 13 531.9

(51) Int. Cl. H04L 9/00

(52) U.S. Cl. 713/189

(57) ABSTRACT

A data carrier having a non-volatile electronic memory for holding large volumes of data and a microcontroller suitable for performing cryptographic operations. Access to the memory is possible only via the microcontroller. The data carrier is characterized in that, before data are stored in the memory, the user is authenticated for a data source using the microcontroller.

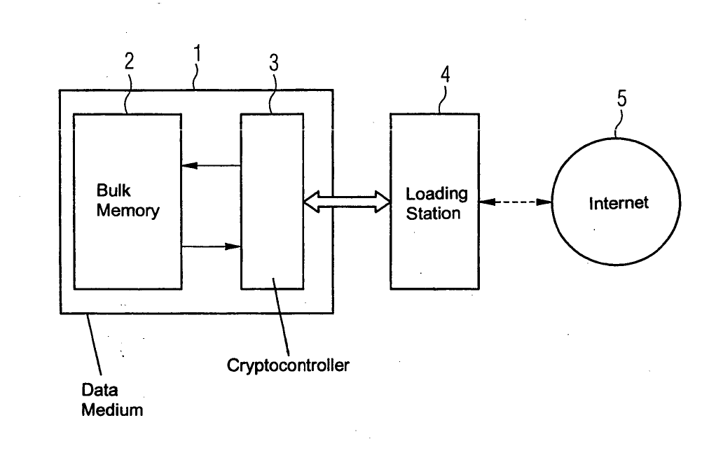

### CROSS-REFERENCE TO RELATED APPLICATION

This application is a continuation of copending International Application No. PCT/DE02/00540, filed Feb. 14, 2002, which designated the United States and was not published in English.

### BACKGROUND OF THE INVENTION

### Field of the Invention

The invention relates to a data carrier having a non-volatile electronic memory for holding large volumes of data and a microcontroller suitable for performing cryptographic operations. Access to the memory is possible only via the microcontroller.

Such data media are used in order to be able to store large volumes of data. This data media is also suitable as replaceable media. Protecting data access using a microcontroller is intended to protect the data against access by unauthorized third parties.

In a relatively new application, replaceable data media of this kind are used to store music files or electronic books loaded from the Internet, for example.

In one possible instance of an application, a normal PC is used as a loading station which obtains the files and stores them on the data carrier. The stored data can then be played back on a transportable playback unit, for example, an MP3 file on a mobile MP3 player.

In other applications, such data media serve as a replacement for diskettes or replaceable hard disks. In this case, sensitive data that need to be protected against access by unauthorized third parties are often stored. For this, the file can be encrypted and can then subsequently be stored on the data carrier in encrypted form. This means a greater level of effort, however, so that the encryption is dispensed with in many cases.

The possibilities mentioned prevent data from being able to be read by unauthorized third parties. In many cases, however, the person to whom data are transmitted is also not irrelevant to the data source, for example when transmitting data subject to a fee. This problem cannot be solved by the apparatuses mentioned above.

### SUMMARY OF THE INVENTION

It is accordingly an object of the invention to provide a data carrier which overcomes the above-mentioned disadvantages of the prior art apparatus of this general type.

In particular, it is an object of the invention to provide a data carrier that is suitable for holding large volumes of data, and where both a high level of security for the stored data and the controlled data output are made possible.

This object of the invention is achieved by providing a data carrier of the type mentioned in the introduction constructed such that, before data are stored in the memory, the microcontroller authenticates the user for a data source. The inventive design of the data carrier ensures that data are always stored in the memory in encrypted form. At the same time, the microcontroller is used to authenticate the user. While the encrypted storage allows the data to be protected for a user, the authentication of the user allows the data source to ensure that data are output only to a particular user.

With the foregoing and other objects in view there is provided, in accordance with the invention, a data carrier including: a non-volatile electronic memory having a memory capacity of greater than 1 Mbyte for holding data; and a microcontroller configured for performing cryptographic operations. Access to the memory is possible only via the microcontroller. The microcontroller is constructed for authenticating the user, for a data source, before data are stored in the memory.

In one preferred embodiment, the memory is larger than 1 Mb and is in the form of a chip card.

Other features which are considered as characteristic for the invention are set forth in the appended claims.

Although the invention is illustrated and described herein as embodied in a data carrier, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The sole drawing FIGURE shows an inventive data carrier in a configuration for loading data from the Internet.

### DESCRIPTION OF THE PREFERRED EMBODIMENTS

Referring now to the sole drawing FIGURE in detail, there is shown a data carrier 1 having a non-volatile bulk memory 2 with a storage capacity of, typically, greater than 1 Mb. For the memory chip, it is possible to use various technologies, for example Flash, OTP (one time programmable), MTP (multiple time programmable) or the like.

The data carrier, which is in the form of a chip card, also has a cryptocontroller 3 which can apply standard encryption methods, preferably RSA or elliptical curves. The data carrier 1 is connected to a loading station 4. The connection can be made via electrical contact areas or contactlessly via an antenna. The loading station 4 provided can be special units or a normal PC providing an appropriate interface for communication with the data carrier 1. The loading station 4 in turn can be connected to the Internet 5.

It is advantageous if the loading station 4 is a mobile radio which can set up wireless communication with the Internet 5. The inventive data carrier can thus be used particularly flexibly.

The microcontroller 3 allows security measures to be provided flexibly. The microcontroller thus undertakes identification of a customer for a service provider in the Internet, and the billing procedure, such as an EC card or cash card. The memory 2 then holds the downloaded data, with the data being stored in the memory 2 in encrypted form.

In one modified application, encrypted data are decrypted by the microcontroller 3 upon download, so that they can be accessed by the user. In this context, both the keys themselves and a certificate are stored in the data carrier for optimum protection of access to the data.

To produce the security mechanisms, it is possible to use all of the known measures from the prior art, since these can all be used by the microcontroller 3 because of the flexible opportunities. Future developments in encryption technology are thus taken into account.

The security of such a card surpasses that of the CD (compact disk) or else of the DVD (digital video disk) and allows “Digital Rights Management” (DRM) in the field of e-commerce.

1. A data carrier, comprising:
a non-volatile electronic memory having a memory capacity of greater than 1 Mbyte for holding data; and
a microcontroller configured for performing cryptographic operations;
access to said memory being possible only via said microcontroller; and
said microcontroller constructed for authenticating a user for a data source before data are stored in said memory.

2. A replaceable data carrier, comprising:
a non-volatile electronic memory having a memory capacity of greater than 1 Mbyte for holding data; and
a microcontroller configured for performing cryptographic operations;
access to said memory being possible only via said microcontroller; and
said microcontroller constructed for authenticating a user for a data source before data are stored in said memory.

3. A chip card, comprising:
a non-volatile electronic memory having a memory capacity of greater than 1 Mbyte for holding data; and
a microcontroller configured for performing cryptographic operations;
access to said memory being possible only via said microcontroller; and
said microcontroller constructed for authenticating a user for a data source before data are stored in said memory.
